(19) United States
(12) Patent Application Publication
(10) Pub. No.: US 2024/0044287 A1
(43) Pub. Date: Feb. 8, 2024

(54) ANTONI CYCLE INTERMITTENT COMBUSTION ENGINE

(71) Applicant: Vladimir Nikolaevich KOSTYUKOV, Volgograd (RU)

(72) Inventor: Vladimir Nikolaevich KOSTYUKOV, Volgograd (RU)

(21) Appl. No.: 18/266,272

(22) PCT Filed: Dec. 8, 2021
(86) PCT No.: PCT/RU2021/000557

§ 371 Date: Jun. 9, 2023

(30) Foreign Application Priority Data
Dec. 9, 2020 (RU) 2020140720
Apr. 23, 2021 (RU) 2021111756
Oct. 12, 2021 (RU) 2021129976

(51) Int. Cl. F02C 5/00; F02C 7/22

(52) U.S. Cl. CPC F02C 5/00; F02C 7/22

(57) ABSTRACT

The invention relates to the field of mechanical engineering and can be used in aircraft and vehicle gas turbine engines and power plants. The present invention achieves the technical result of increasing the power and the energy conversion efficiency of a gas turbine engine, as well as improving the ecological parameters and the weight and size characteristics of the engine. The claimed device contains a cascade gas generator integrated into an engine so that air is fed to a supply port for low-pressure working fluid on one side of a rotor, on the opposite side of which there is a discharge port for low-pressure working fluid; next in the direction of rotation of the rotor there are fuel supply ports and openings having spark plugs mounted therein; and further in the direction of rotation of the rotor there is a discharge chamber, opposite which, on the other side of the rotor, there is a discharge port for high-pressure working fluid, which is connected to a turbine, wherein several rows of channels can be provided in the rotor, the channels in one row being offset from the channels in another row, and the engine can contain a system for injecting a cooling fluid into the rotor channels.

The invention relates to the field of mechanical engineering and can be used in aircraft and vehicle gas turbine engines, in gas turbine and gas-steam power plants, in motors—compressors.

There is a turbojet engine Resonant Pulse Combustors. «Resonant Pulse Combustors: A Reliable Route to Practical Pressure Gain Combustion», Dan Paxson NASA John H. Glenn Research Center Cleveland, OH, International Constant Volume Detonation Combustion Workshop Poitiers, France Jun. 13-16, 2017.

The disadvantages of such a design are low efficiency and low specific power, large dimensions and narrow scope of application.

There is also a wave pressure exchanger, containing a housing with ports for the supply and discharge of the working fluid, inside which a rotatable rotor with channels open from the ends is installed. «Wave Rotor Topping Cycles for Gas Turbine Engines» http://www.grc.nasa.gov/WWW/cdtb/projects/waverotor/

The disadvantage of this design is the low efficiency of the engine with a wave pressure exchanger, especially at partial load.

There is also a cascade pressure exchanger, containing a housing with ports of supplying and discharging of the working fluid built in it, as well as with bypass (mass transfer) channels and a rotatable rotor with channels open from the ends. The exchanger is configured to operate as part of a gas turbine engine or a motor-compressor. “New directions for improving the workflow of gas turbine engines with a cascade pressure exchanger of Kraynyuk”. A. I. Kraynyuk. “Aerospace engineering and technology”. 2010 No 7

The disadvantages of such a design are low efficiency and low productivity, as well as the need to install additional fans and an external combustion chamber, which complicates the design of an engine or a motor-compressor based on it.

The present invention achieves the technical result of increasing the power and the energy conversion efficiency of a gas turbine engine, improving the ecological parameters and the weight and size characteristics of the engine, simplifying its design, and the expansion of the scope of application of pressure exchangers.

The technical result is achieved by the fact that the Antoni cycle intermittent combustion engine, comprising at least one air (gas) compression device based on a cascade pressure exchanger, for example, a cascade gas generator, systems of fuel supply, ignition, start-up, monitoring, control, for example cooling, differs in that it contains at least one cascade gas generator made on the basis of a cascade pressure exchanger, including a housing in which a rotor is installed with the possibility of rotation, with channels made along the circumference of the rotor parallel to the shaft (axially), or radially, or diagonally, or combined axial and radially, from the side of the inlet and outlet openings of the channels to the ends of the rotor with a minimum gap, for example, with the possibility of regulating it and, or, for example, with the possibility of performing any gap seals, the walls of the housing are adjacent, in which ports (windows) are formed with the possibility of feeding into the rotor channels and removing working fluid (working fluids) from them, when the rotor rotates, a cascade gas generator is integrated into the engine, for example, in such a way that a gas duct with a low-pressure working fluid, for example, air from the atmosphere, from a fan, or from a low-/medium-/high-pressure compressor, or air having passed a part of the low-pressure stages of a high-pressure compressor, is connected to the supply port of the low-pressure working fluid of a cascade gas generator on one side of the rotor, and on the opposite side of the rotor, for example, on the contrary, possibly, with the possibility of earlier opening of the rotor channels into it, a port is built in the housing for the discharge of a low-pressure working fluid, for example, combustion products and/or a mixture of air and combustion products, for example, into the atmosphere (into the second circuit of a bypass turbojet engine) or into a medium- or low-pressure turbine, further, along the direction of rotation of the rotor, from the inlet side or from the outlet side of the low-pressure working fluid (or from both sides), fuel supply ports, in which, for example, fuel injectors are mounted, with the possibility of injecting liquid or compressed gaseous (or pulverized) fuel under pressure into the rotor channels, are built in the wall of the housing in, and for example, further, after that along the direction of rotation of the rotor, openings are made in which spark plugs and/or detonation initiators are installed, further, along the direction of rotation of the rotor, for example, from the side of the low-pressure working fluid supply port, the port of discharge of the working fluid into the pressure cavity (pressure channel) is made, then, along the direction of rotation of the rotor, the port of supply of the working fluid to the rotor channels from the pressure cavity is made, opposite, (possibly with some displacement along the direction opposite to the rotation of the rotor) the port of discharge of the high-pressure working fluid made in a housing, for example, on the side of the port of discharge of a low-pressure working fluid and connected to an expansion device, for example in the form of a turbine, for example a high pressure one, meanwhile, the walls of the housing located between the ports are made to ensure the possibility of overlapping of the inlet and outlet openings of at least one rotor channel when the rotor rotates, also, along the direction of rotation of the rotor, behind and in front of the port of discharge of the low-pressure working fluid, and/or on the opposite side of the rotor behind and in front of the port of supply of the low-pressure working fluid, a number of ports (windows) are connected in pairs by bypass (mass transfer) channels in such a way that the ports built, for example, behind the port of discharge of the low-pressure working fluid, along the direction of rotation of the rotor, are connected to the ports built in front of the port of discharge of the low-pressure working fluid, along the direction of rotation of the rotor, with the possibility of a sequential increase in pressure in the rotor channels, as the channels are removed from the discharging port of the low-pressure working fluid, when the rotor rotates, and the ports built, along the direction of rotation of the rotor, in front of the port of discharge of the low-pressure working fluid, are made with the possibility of successively reducing the pressure of the working fluid in the channels of the rotor, during its rotation, as the channels approach the port of discharge of the low-pressure working fluid.

In addition, the engine differs in that in the rotor of a cascade gas generator, for example, along the radius of the rotor, several rows of channels are made, at least two rows, for example, with the displacement of channels in some rows relative to channels in other rows, the walls of the housing located between the ports are made with the possibility of overlapping the inlet and outlet openings of at least one channel in each row of the rotor channels, for example, sequentially, when the rotor rotates.

In addition, the engine differs in that the cascade gas generator is made in the form of a cascade motor-compressor, meanwhile, the fuel supply ports, and the openings located further along the direction of rotation of the rotor, in which spark plugs and/or detonation initiators are installed, are built opposite to a part of the rows of channels, at least, opposite to one row of channels, for example, located in the middle rows of channels, while from the side of the discharge port of the high-pressure working fluid of the cascade motor-compressor, this row (these rows) of channels is blocked by the wall of the housing, despite the fact that the outlet openings of the channels in the other row (in other rows) are connected to the discharge port of the high-pressure working fluid, and on the opposite side, the inlet openings of all rows of rotor channels are open into the pressure cavity connecting all the inlet openings of all channels exiting into it.

In addition, the engine differs in that the pressure cavity (channel) is connected by a high-pressure bypass channel directly and/or through a port made on the opposite side of the rotor from the port of discharge of the working fluid into the pressure cavity (channel) with an additional port of supply of the working fluid into the rotor channels, at least one row of rotor channels, with that port built—along the direction of rotation of the rotor—in front of the sector of the wall of the housing, in which the fuel supply ports are built, for example, on the same side of the housing as the fuel supply ports, or on the opposite side of the rotor, and it is also possible that on both sides of the rotor in the walls of the housing additional ports for supplying the working fluid to the rotor channels are built, with these ports connected to high-pressure bypass channels.

In addition, the engine differs in that in the housing of the cascade gas generator, along the direction of rotation of the rotor, in the part in front of the pressure cavity or in front of the port of discharge of the working fluid into the pressure cavity (channel), a port or opening is built connected by an ultra-high-pressure bypass channel with a port or opening built on the same side of the rotor in the wall of the housing in front of or behind the sector of the wall of the housing, along the direction of rotation of the rotor, with fuel supply ports and openings with spark plugs and/or with detonation initiators, or this opening (port) is built right behind the fuel supply port, along the direction of rotation of the rotor, for example, at the same level (in the same sector) with openings with spark plugs and/or with detonation initiators.

In addition, the engine differs in that at least one row of rotor channels is designed with the possibility of periodically combining channels with a high-pressure cooling air (gas) discharge port, which, in turn, is connected to the cooling system of, at least, high-pressure turbine, meanwhile the bypass (mass transfer) channels, connected to the ports built in the housing from the side of this row of channels, are built from the side of the supply port of the low-pressure working fluid of the cascade gas generator, meanwhile, along the direction of rotation of the rotor, behind the port connected to the last bypass (mass transfer) channel, which is built behind the low-pressure working fluid supply port, a port connected by a high-pressure bypass channel with a pressure cavity (channel) can be built, and then, along the direction of rotation of the rotor, a port is built, which is connected by an ultra-high-pressure bypass channel with a port built in the housing of a cascade gas generator, along the direction of rotation of the rotor, in front of the port of discharge of the working fluid into the pressure cavity, then, along the direction of rotation of the rotor, from the side opposite to the high-pressure cooling air discharge port, a port connected to the air cavity (channel) is built, after which, along the direction of rotation of the rotor, in the wall of the housing a port is built, connected to the supply from the air cavity (channel), made opposite (possibly with some displacement) to the high-pressure cooling air discharge port, further, along the direction of rotation of the rotor, a port is built connected to the port of discharge of the working fluid into the pressure cavity (channel), after which a number of ports are built connected by bypass (mass transfer) channels connecting ports built in the wall of housing of the cascade gas generator, in front of the low-pressure working fluid supply port, along the direction of rotation of the rotor, and behind it.

In addition, the engine differs in that the discharge port of the high-pressure working fluid of a cascade motor compressor (cascade gas generator in the form of a motor compressor) is connected to at least one heat supply device, for example to a regenerative or recuperative heat exchanger and/or to a combustion chamber, the outlet of which is connected to a turbine, for example a high-pressure one, meanwhile, the cooling system of the turbine, at least of a high-pressure one, can also be connected to the discharge port of the high-pressure working fluid of the cascade motor compressor, and the side of the heat exchanger, where the heat supply to the high-pressure working fluid is located, can be connected, with the possibility of heat removal from the low-pressure working fluid, for example to a channel connected to the discharge port of the low-pressure working fluid of a cascade motor-compressor (cascade gas generator in the form of a motor-compressor).

In addition, the engine differs in that the discharge port of the high-pressure working fluid is connected to at least one nozzle of the active flow of at least one single-stage ejector, and the discharge port of the low-pressure working fluid can be connected to the input of the passive flow of this ejector (or ejectors), the output of which can be connected to the turbine.

In addition, the engine differs in that the rotor shaft of a cascade gas generator (motor-compressor) is connected to the drive, for example from a gas turbine or electric motor, with the possibility of regulating the rotor speed and/or the rotor is made with the possibility of self-rotation, for example by means of special nozzles (channels) built in separate ports for supplying the working fluid to the rotor channels, for example also with the possibility of regulating the rotor speed, meanwhile the housing of the cascade gas generator can be sealed.

In addition, the engine differs in that between the compression devices of the working fluid, for example air between compressors and/or in the gas duct connected to the low-pressure working fluid supply port of the cascade gas generator (motor-compressor), at least one heat removal device is installed, for example a heat exchanger-cooler and/or a pressurized water (condensate) injection system.

In addition, the engine differs in that the discharge of the high-pressure working fluid of the cascade gas generator is connected to the jet nozzle of the first circuit of the air-jet engine, meanwhile, an afterburner can be made in front of this nozzle, and the discharge port of the low-pressure working fluid of the cascade gas generator can have an output into the second circuit of the air-jet engine in which the gas flow from the air intake can be an active flow in relation to the gas from the discharge port of the low-pressure working fluid of the cascade gas generator and can be a passive flow in relation to the active flow of the working fluid from the first circuit of the engine.

In addition, the engine differs in that in the gas (air) path, behind the compressor of the gas turbine engine, a steam-gas cascade pressure exchanger is built, the low-pressure working fluid supply port of which is connected to the compressor, and the high-pressure working fluid supply port is connected to a steam line connected to a generator, for example water vapor (steam generator), for example to a heat recovery boiler installed in the gas path behind or in front of the low-pressure turbine of a gas turbine engine, the port of discharge of the high-pressure working fluid of the steam-gas cascade pressure exchanger is connected to the port of supply of the low-pressure working fluid of the cascade gas generator, and the port of discharge of the low-pressure working fluid, for example water vapor, is connected to at least one steam condenser, for example to a steam water (condensate) heater through at least, one steam and/or gas turbine, meanwhile, the steam water (condensate) heater is connected, at least, to the heat recovery boiler (steam generator) by a water (condensate) supply pipeline with a pump and for example a water treatment device, and may contain a fan or compressor with the possibility of air removal, for example to the low-pressure working fluid supply port of a steam-gas cascade pressure exchanger, and in the gas path, behind and in front of the low-pressure turbine stages, condensate separators can be installed connected by a condensate supply pipeline, at least with a steam water (condensate) heater, and additional coolers can also be installed, for example in the form of a heating system circuit.

In addition, the engine differs in that the ports of supply and discharge of the low-pressure working fluid of the cascade gas generator are made with the possibility of partial displacement of for example half of the combustion products into the port of discharge of the low-pressure working fluid, and the other part, for example half, into the port of discharge of the high-pressure working fluid, meanwhile, the ports connected by bypass channels, at least most of them, are built on the side of the discharge port of the high-pressure working fluid, and for example the fuel supply port is built on the side opposite to the port of the discharge of the high-pressure working fluid.

In addition, the engine differs in that it contains a cascade motor-compressor, with a cascade gas generator built behind it, installed in the beginning, in the gas (air) path, along the direction of gas (air) movement, meanwhile, the low-pressure working fluid supply port of the cascade motor-compressor is connected to the compressor of the gas turbine engine, the high-pressure working fluid discharge port of the cascade motor-compressor is connected to the low-pressure working fluid supply port of the cascade gas generator by a channel that may contain a convective intercooler, or a water (condensate) injection system, the discharge port of the high-pressure working fluid of the cascade gas generator is connected to a high-pressure turbine, and the discharge port of the low-pressure working fluid is connected, for example, to a medium-pressure turbine, while the discharge port of the low-pressure working fluid of the cascade motor-compressor is connected, for example, to a low-pressure turbine.

In addition, the engine differs in that it contains a device for injecting coolant into the rotor channels, meanwhile, in the walls of the cascade gas generator housing, including one made in the form of a motor-compressor, opposite to at least part of the channels in the rotor, which on the opposite side are combined completely or partially with ports connected to bypass (mass transfer) channels, with the possibility of increasing the pressure in these channels of the rotor, and possibly on the opposite side from the port connected to the high-pressure bypass channel, made with the possibility of increasing the pressure in these channels of the rotor, nozzles are made with the possibility of injection into the channels under pressure of a coolant, for example water, and possibly, at least in part of the channels, injection of both fuel and/or a mixture of fuel, for example, with water, meanwhile, at least one row of rotor channels, made to ensure the possibility of periodic combination with a high-pressure cooling air (gas) discharge port, which is connected to the cooling system of at least a high-pressure turbine, contains nozzles for injecting coolant (water) built in the housing, on the same side as the high-pressure cooling air discharge port, also possibly built on the same side as the channels, combined on the opposite side with a port connected to an ultra-high pressure bypass channel, built with the possibility of increasing the pressure in these channels of the rotor.

In addition, the engine differs in that in the walls of the housing of the steam-gas cascade pressure exchanger, opposite the channels in the rotor, on the opposite side combined completely or partially, with ports, connected to the bypass (mass transfer) channels, with the possibility of increasing the pressure in these channels of the rotor and possibly partially, opposite of the port of supply of the high-pressure working fluid to the steam-gas cascade pressure exchanger, nozzles are made with the possibility of injection of coolant (water) into the rotor channels under pressure, connected possibly through a pump (pumps), for example, to a cooling water tank, for example preheated.

In addition, the engine differs in that it contains a cascade pressure exchanger, with a cascade gas generator built behind it, installed in the beginning, in the gas path, along the direction of gas (air) movement, meanwhile, the supply port of the high-pressure working fluid of the cascade pressure exchanger is connected to the outlet from the combustion chamber, the inlet of which is connected to the high-pressure compressor, the supply port of the low-pressure working fluid of the cascade pressure exchanger is connected to the outlet from the medium- or low-pressure compressor, the discharge port of the high-pressure working fluid of the cascade pressure exchanger is connected to the supply port of the low-pressure working fluid of the cascade gas generator by a channel that may contain a convective intercooler, or a water (condensate) injection system, the discharge port of the high-pressure working fluid of the cascade gas generator is connected to a high-pressure turbine, and the discharge port of the low-pressure working fluid is connected, for example, to a medium-pressure turbine, while the discharge port of the low-pressure working fluid of the cascade pressure exchanger is connected, for example, to a low-pressure turbine.

In addition, the engine differs in that it contains a cooling system for at least the channels of the rotor of a cascade gas generator (motor-compressor), for example, made in the form of nozzles (nozzle) for injection of coolant under pressure, for example water, into the channels of the rotor, installed in ports (port) built in the wall of the housing, at least from the side of the bypass (mass transfer) channels, along the direction of rotation of the rotor, behind the port of discharge of the low-pressure working fluid.

In addition, the engine differs in that it contains at least one pulse damping device (pressure equalization) of gas in the gas path, at least in front of the high-pressure turbine, for example, in the form of a receiver.

### DESCRIPTION OF THE DRAWINGS

FIG. 1 Antoni cycle intermittent combustion engine. The sweep of the cascade gas generator rotor is shown.

FIG. 2 Multi-row gas generator of an Antoni cycle intermittent combustion engine, made in the form of a motor-compressor. On the left—front view, incision, on the right—side view, incision.

FIG. 3 Multi-row gas generator of an Antoni cycle intermittent combustion engine, made in the form of a compressor motor. Rear view, incision.

FIG. 4 Antoni cycle intermittent combustion engine in the form of a two-circuit turbojet engine.

FIG. 5 Antoni cycle intermittent combustion engine with an evaporative system for air cooling during compression.

FIG. 6 Antoni cycle intermittent combustion engine with an evaporative system for air cooling during compression. On the left the sweep of the cascade gas generator rotor is shown. On the right the sweep of the cascade gas generator rotor in terms of compression, cooling the air turbine, is shown.

FIG. 7 Antoni cycle intermittent combustion engine in the form of a two-circuit turbojet engine with a gas generator made in the form of a cascade motor-compressor and combustion chamber.

FIG. 8 Antoni cycle intermittent combustion engine with a gas generator made in the form of a cascade motor-compressor, a recuperative heat exchanger and a combustion chamber.

FIG. 9 Antoni cycle intermittent combustion engine as part of a gas-steam power plant.

Antoni cycle intermittent combustion engine contains a cascade gas generator 1, in the housing 2 of which the rotor 3 is made with one or more rows of 4 channels 5, with inlet 6 and outlet 7 openings, with the possibility of their periodic overlap, when the rotor 3 rotates, by the walls of the housing 2 and periodic combination with the low-pressure working fluid supply port 8, low-pressure working fluid discharge port 9, high-pressure working fluid discharge port 10, with ports connected by bypass (mass transfer) channels 11, with fuel supply ports 12, for example with nozzles, with openings with spark plugs and/or detonation initiators 13, possibly with an additional port 14, It can contain, separated by the wall of the housing 2, a port of discharge 15 from the pressure cavity (channel) 17 and a port of supply 16 of the working fluid into the pressure cavity (channel) 17, may contain a combined discharge-supply port 18 of the working fluid into and out of the pressure cavity 17, may contain a low-pressure compressor (or fan) 19, a high (or medium) pressure compressor 20, may contain high—21, medium—22 and low-pressure 23 turbines, may contain a constant pressure combustor 24, a coolant injection system 25 into the channels 5 of the rotor 3, the system 26 of the rotor 3 rotations, a steam-gas cascade pressure exchanger 27, the bounds of the working fluids 28, an intercooler 29, a recuperative heat exchanger 30, an electric generator 31, a high-pressure bypass channel 32, a water injection device into the air path 33, may contain a high-pressure cooling air (gas) discharge port 34, a port connected to the outlet 35 into the air channel 36 and a port connected to the supply 37 from the air channel 36, a steam water heater 38, heat recovery boiler (steam generator) 39, water treatment device 40, cascade motor-compressor 41, air discharge fan 42 from steam water heater 38, condensate separator 43, port (opening) of discharge 44 and port (opening) of supply of ultra-high-pressure gas 45, cooling system 46 for channels 5 of rotor 3, high-pressure working fluid supply port 47 of steam-gas cascade pressure exchanger 27, additional cooler circuit (for heating system) 48, ultra-high-pressure bypass channel 49 of the cascade gas generator 1.

Antoni cycle intermittent combustion engine works as follows.

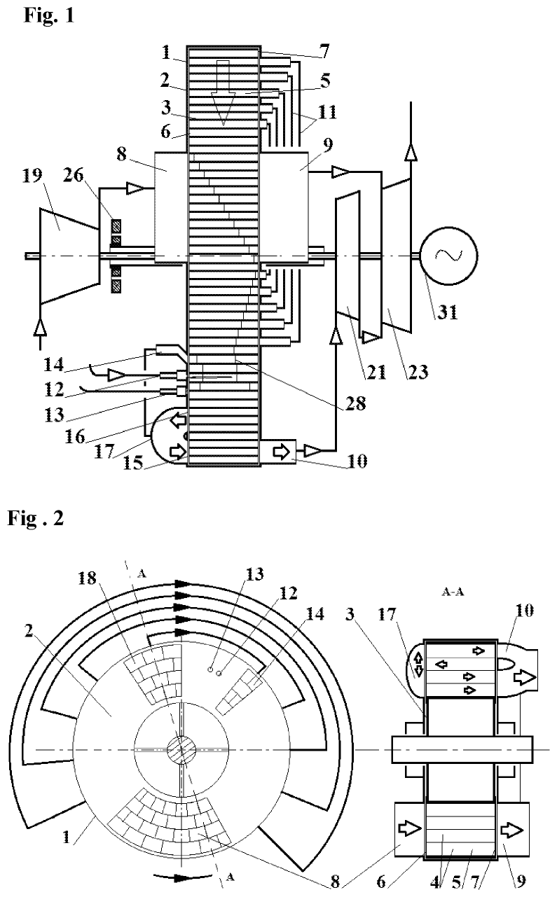

When starting the engine, for example, due to the rotation of the shaft from some starter device (not shown in the diagrams), in a low-pressure compressor 19 (FIG. 1) atmospheric air is compressed, which then enters in the port of supply of the low-pressure working fluid 8 of the cascade gas generator 1, the rotor 3 of which rotates during start-up, for example, due to the control system 26 of the rotor 3 rotations. Through the inlet openings 6, the channels 5 in rows 4 are filled with air, and when the rotor 3 rotates, they are combined with the bypass (mass transfer) channels 11, and hot combustion products, under pressure, enter the air-filled channels 5 and compress the air in the channels 5, which are then combined with the fuel supply port 12, by injectors, for example, liquid fuel, are injected into the channels 5, after which these channels 5 are combined with holes with spark plugs 13 and the fuel-air mixture filling the channels 5 ignites, which are then combined with the fuel supply port 12, meanwhile, for example, liquid fuel is injected into the channels 5 by injectors, after which these channels 5 are combined with holes with spark plugs 13 and the fuel-air mixture filling the channels 5 ignites. At the same time, the pressure and temperature of the working fluid in the channels 5 increases. Then, these channels 5, when the rotor 3 rotates, are combined with the supply port 16 of the working fluid into the pressure cavity 17, into which part of the combustion products rushes. Further, when the rotor 3 rotates, the channels 5 are blocked by the wall of the housing 2, and then they open, from the side of the inlet openings 6, into the discharge port 15 of the working fluid from the pressure cavity 17, and from the side of the outlet openings 7 are combined with the port of discharge of the high-pressure working fluid 10, and the combustion products, with lower pressure and temperature, but with minimal flow pulsations, and possibly without pulsations, enter the high-pressure turbine 21, expand in it, then expand in the low-pressure turbine 23, causing the shaft with the low-pressure compressor 19 and the electric generator 31 to rotate, then they are released into the atmosphere. Further, when the rotor 3 rotates, the channels 5, which have already passed the high-pressure working fluid outlet port 10, but are still filled with hot combustion products with residual pressure, are combined with ports connected by bypass (mass transfer) channels 11, while in these channels 5 the gas pressure decreases stepwise, and in channels 5, approaching to the fuel supply port 12, the pressure of air and gas filling these channels 5 increases stepwise. In the channels 5, approaching, when the rotor 3 rotates, to the port of discharge of the low-pressure working fluid 9, the gas pressure drops stepwise and when the channel 5 is combined with the port of discharge of the low-pressure working fluid 9, the gas enters (is pushed out by air entering the inlet openings 6 of the channels 5 from the port of supply of the low-pressure working fluid 8) into the low-pressure turbine 23, expands in it and causes the shaft with the compressor 19 and the electric generator 31 to rotate, after which it is released into the atmosphere.

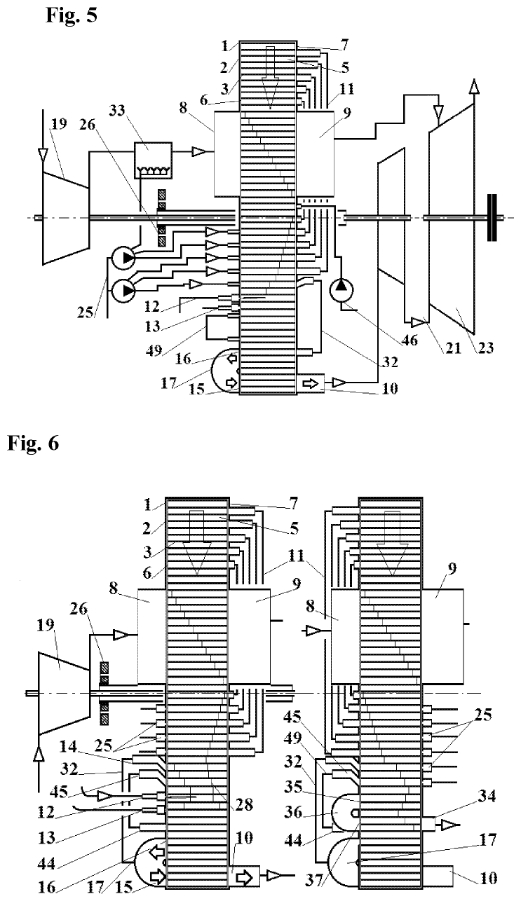

Before fuel injection into the channels 5 through the fuel supply port 12 and before the ignition of the fuel-air mixture, for example, due to the spark plugs located in the holes 13, the air in the channels 5 can be additionally compressed by gas, due to the combination of channels 5 with an additional port 14 connected by a high-pressure bypass channel 32 with a pressure cavity (channel) 17 (FIG. 1, FIG. 2, FIG. 5, FIG. 6). Also, the air in the channels 5 can be even more compressed, and the fuel-air mixture can ignite, due to the combination of channels 5 with a port connected to by-pass channel of ultra-high pressure 49. ((FIG. 5, FIG. 6).

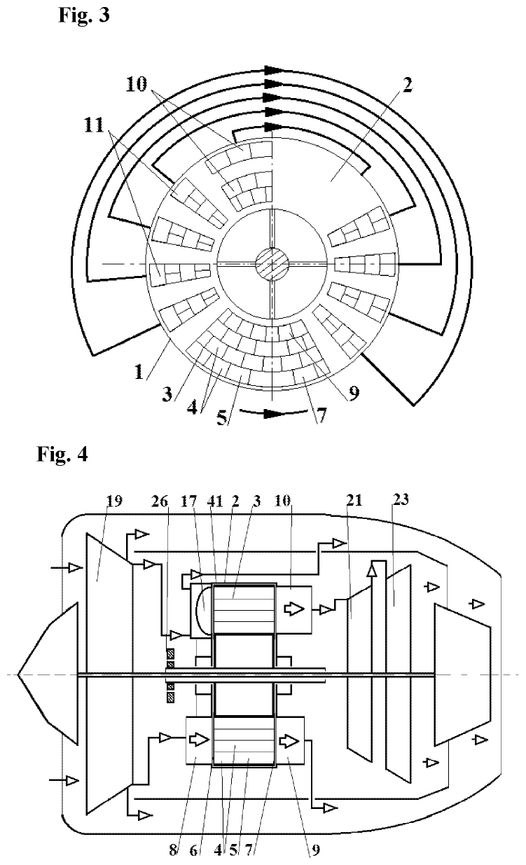

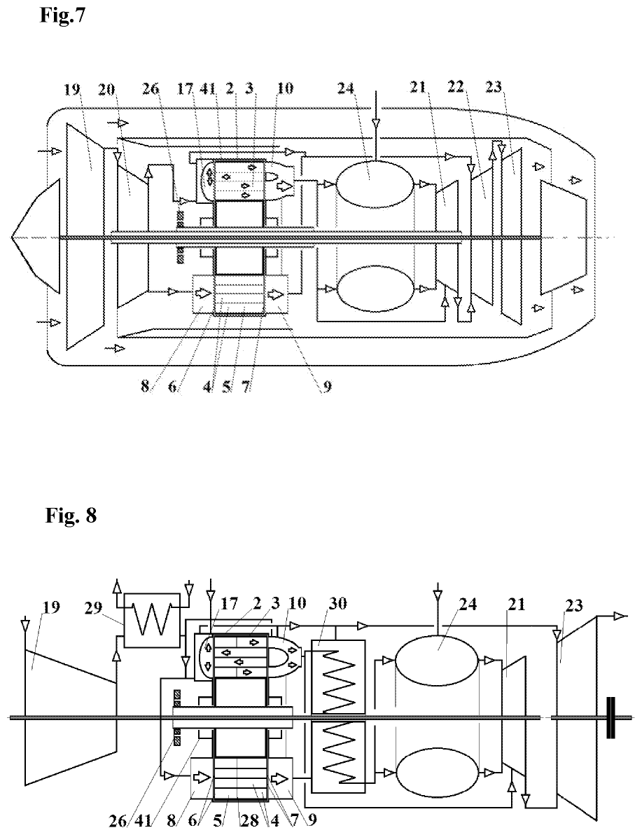

It is possible that only part of the rows 4 of channels 5 are combined, when the rotor 3 rotates, with the fuel supply ports 12 (FIG. 2, FIG. 3). At the same time, for example, in a two-circuit turbojet engine, when a low-pressure compressor 19 (fan) and a medium-pressure compressor 20 (FIG. 7) are operating, the air enters the supply of the low-pressure working fluid 8 of the cascade gas generator 1, made in the form of a cascade motor-compressor 41. Through the inlet openings 6 the channels 5 in rows 4 are filled with air and, when the rotor 3 rotates, for example, one of the rows 4 of channels 5 is combined with the fuel supply port 12, while, for example, liquid fuel is injected into the channels 5 by injectors, after which these channels 5 are combined with holes with spark plugs 13 and fuel-air mixture, filling these channels 5 ignites. At the same time, the pressure and temperature of the working fluid in the channels 5 increases. Then these channels 5, when the rotor 3 rotates, are combined with the combined port of discharge-supply of the working fluid 18 into the pressure cavity 17. At the same time, from side of the outlet openings 7, this row of channels 5 is blocked by the wall of the housing 2, so the combustion products rush into the pressure cavity 17, and then into other rows 4 of channels 5, which from side of the outlet openings 7 are combined with the outlet port of the high-pressure working fluid 10, and combustion products, with slightly lower pressure and with a temperature, but with minimal flow pulsations, and possibly without pulsations, push the air from the channels 5 into the combustor 24 into which additional fuel is supplied, after which the combustion products (mixed with air) enter the high-pressure turbine 21, expand in it, rotating the medium-pressure compressor 20, then expand in the medium-pressure turbine 22 and in the low-pressure turbine 23, causing the low-pressure compressor 19 (fan) to rotate.

Part of the combustion products from the discharge port of the low-pressure working fluid 9 also enter the medium-pressure turbine 22 and expand in it, then, in the low-pressure turbine 23, performing work, after which the entire flow of combustion products expands in the nozzle. In this scheme, the cascade gas generator 1 acts as a high-pressure motor-compressor 41. When an intermittent combustion engine is running in the composition, for example, of a small turbofan engine, after starting the engine, in the low-pressure compressor 19 (fan) (FIG. 4), air is compressed, part of the compressed air enters the second circuit of the turbojet, and the other part of the air, for example, additionally compressed in the stages of the low-pressure compressor 19 enter in the port of supply of the low-pressure working fluid 8 of the cascade gas generator 1, in which combustion products are generated, which enter the high-pressure turbine 21, expand in it, and, for example, in the low-pressure turbine 23, causing the low-pressure compressor 19 (fan) to rotate, after which they expand in the nozzle of the first circuit of the turbofan engine. From the outlet port of the low-pressure working fluid 9, another part of the combustion products enters the second circuit of a two-circuit turbojet engine, and mixes with air, after which they expand in the nozzle, for example, together with combustion products from the first circuit of the engine.

The cascade gas generator 1 can have a pressure cavity 17, or it can be made without it (not shown in the drawings). Meanwhile, the flow of the working fluid leaving the outlet port of the high-pressure working fluid 10 can be pulsating. The installation of an ejector (not shown in the drawings) will allow to reduce the pulsating effect, and the attached mass for the ejector can serve as a gas flow from the outlet port of the low-pressure working fluid 9 of the cascade gas generator 1, and a gas flow from the outlet port of the low-pressure working fluid 9 of the cascade gas generator 1 can serve as the attached mass for the ejector. The combined mass of the working fluid, with a pressure and temperature slightly lower than after the discharge port of the high-pressure working fluid 10, but with minimal pulsations, enters the combustion chamber 24 if the cascade gas generator 1 is made in the form of a cascade motor compressor 41, or directly expands in the turbine.

The channels 5 of the rotor 3 can be partially filled with air entering the channels 5 from the low-pressure working fluid supply port 8 (not shown in the drawings). At the same time, part of the combustion products is recycled in the rotor 3, increasing the efficiency of the engine and reducing the formation of nitrogen oxides.

The formation of nitrogen oxides can also be reduced by preliminary partial mixing of air with combustion products, due to the implementation of a high-pressure bypass channel 32 and, or bypass (mass transfer) channels 11, in the side of the fuel supply port 12, in addition, this will contribute to self-ignition of fuel (FIG. 1).

The use of intermediate cooling of compressed air in the cooler 29 (FIG. 8) allows to increase the power and efficiency of Antoni cycle intermittent combustion engine, and its combination with heat recovery in the heat exchanger 30 further increases the efficiency of the cycle.

Water injection for intermediate cooling (FIG. 5, FIG. 6) of compressible air, at least into the air path in front of the low-pressure working fluid supply port of the cascade gas generator 1, in front of the medium-pressure compressor 20 and behind it (and possibly before the low-pressure compressor 19) increases power and efficiency, reduces thermal stress and improves the environmental characteristics of the engine.

When the engine is running using evaporative cooling (wet compression), in a low-pressure compressor 19 (FIG. 5) atmospheric air is compressed, which then enters the channel, with a water injection device into the air path 33, while the liquid, for example, water evaporates and the air cools, after which the air is supplied to the port of supply of the low-pressure working fluid 8 of the cascade gas generator 1, the rotor 3 of which rotates, resulting in channels 5, filled with air, are combined with bypass (mass transfer) channels 11, and hot combustion products, under pressure, enter the channels filled with air, and compress the air in the channels 5.

At the same time, from the side of the air filling them, the channels 5 are combined with the nozzles of the coolant injection system 25 into the channels 5 of the rotor 3 and the coolant is injected into the channels 5, for example water, which evaporates and the air is cooled. It is also possible that to at least part of the channels 5, through the injectors of the injection system 25, a mixture of water and fuel is supplied, for example in the form of an emulsion, while water and fuel simultaneously evaporate, and the fuel is pre-mixed with air, improving the subsequent combustion process. It is also possible that the coolant, that is injected into at least part of the channels 5 of the cascade gas generator 1 for cooling the compressible air, is only fuel. Further, when the rotor 3 rotates, the channels 5 are combined with the fuel supply ports 12 with fuel injectors and fuel is injected into the channels 5 under pressure, and the fuel, when the engine is started, ignites through the holes 13 with spark plugs, and in the future, it can ignite due to an opening (port) connected to an ultra-high pressure bypass channel 49, through which hot gas (plasma) enters the channels 5 and ignites the fuel-air mixture, located in the channels 5, and when it is ignited, due to the fact that the air has been pre-cooled, when heat is supplied to it, the degree of pressure increases in the channels 5 of the rotor 3, which form constant volume combustors with the walls of the housing 2, and that increases the efficiency of the cycle.

For example, one row 4 of channels 5 of the rotor 3 can be allocated to compress air intended for cooling at least the high-pressure turbine 21. At the same time, the air entering through the low-pressure working fluid supply port 8 into this row 4 of channels 5, when the rotor 3 rotates, is compressed due to bypass (mass transfer) channels 11, after which the air is compressed due to the combination of channels 5 with an additional port 14, connected by a high-pressure bypass channel 32 with a pressure cavity (channel) 17 (FIG. 6). Then the cooling air in the channels 5 is compressed, due to the port connected to the ultra-high pressure bypass channel 49. At the same time, from the side of the air filling them, the channels 5 can be periodically combined, when the rotor 3 rotates, with the injectors of the coolant injection system 25, for example water into the channels 5 of the rotor 3, so that the cooling air is intensively cooled during compression. Further, when the rotor 3 rotates, the channels 5 with cooling air are combined with a port connected to the outlet 35 into the air cavity (channel) 36, while the air rushes into this cavity (channel) and its pressure drops, then the channels 5 with cooling air are combined simultaneously with the port connected to the supply 37 from the air cavity (channel) 36, and on the opposite side, with a high-pressure cooling air (gas) discharge port 34 connected to the cooling system, at least of the high-pressure turbine 21. At the same time, due to the fact that in front of the high-pressure cooling air (gas) discharge port 34 and in the air cavity (channel) 36 the cooling air pressure is the same, the pulsations of the cooling air flow at the inlet to the cooling system will be minimal, or will be absent. Further, when the rotor 3 rotates, the channels 5 are combined with the port that exits into the pressure cavity (channel) 17 and the gas pressure in the channels 5 drops. Then the channels 5 are combined, when the rotor 3 rotates, with the bypass channels 11, while the gas in the channels 5 expands stepwise, compressing the air in the channels 5, after which the channels 5 are combined with the outlet port of the low-pressure working fluid 9 and the gas (combustion products) are pushed out of the channels 5 by a new batch of air. Then the cycle repeats.

The use of sequentially installed, along the course of gas movement, at first, cascade gas generator 1 in the form of a motor compressor (not shown in the diagrams), the port of discharge of a high-pressure working fluid 10 of which is connected to the port of supply of a low-pressure working fluid 8 of a cascade gas generator 1, which port of discharge of a high-pressure working fluid 10 is connected to a high-pressure turbine 21, allows to increase the air pressure in front of the cascade gas generator 1 with greater efficiency than in a blade compressor, respectively—to increase the maximum pressure in the cycle and the efficiency of the engine.

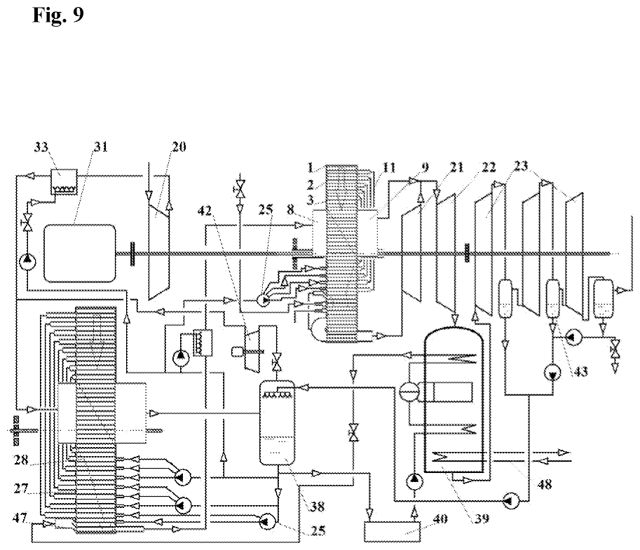

The engine may contain a pressure heat recovery boiler (steam generator) 39 made in front of the low-pressure turbine 23 (FIG. 9), or an atmospheric one made behind the low-pressure turbine, and this boiler is connected, on the same side as the superheated steam outlet, to the high-pressure working fluid supply port 47 of the steam-gas cascade pressure exchanger, meanwhile, the outlet from the compressor, for example a medium-pressure one 20, is connected to the supply port of the low-pressure working fluid of the steam-gas cascade pressure exchanger 27, and high-pressure steam is used as a compressive medium, which is generated in the recovery boiler 39 and compresses (exchanges pressure) the air filling the channels of the steam-gas cascade pressure exchanger 27 and pushes it out to the low-pressure working fluid supply port 8 of the cascade gas generator 1. After the steam expands in the steam-gas cascade pressure exchanger 39, it enters a steam or gas turbine (not shown in the drawing) and/or in a steam water heater 38, meanwhile the water condensate is separated in the condensate separators 43 when the gas expands in the low-pressure turbine 23 and beyond, and is supplied by a pump for example into the steam water heater 38 and further into the heat recovery boiler 39, for example, through a water treatment device 40, it heats up in it, evaporates, overheats and is filed into a steam-gas pressure exchanger 27. Then the cycle repeats. The remaining air in the steam water heater 38 is removed by means of an air outlet fan (compressor) 42 and fed to the low-pressure working fluid supply port of the steam-gas cascade pressure exchanger 27, excess heat is removed from the cycle by means of an additional gas cooler, for example, made in the form of a heating system circuit 48.

The engine may contain a cascade pressure exchanger installed in the gas path, initially, along the course of gas (air) movement (not shown in the drawings), after which a cascade gas generator 1 is built, while the high-pressure working fluid supply port of the cascade pressure exchanger is connected to the outlet from the combustion chamber, the inlet of which is connected to a high-pressure compressor, the low-pressure working fluid supply port of the cascade pressure exchanger is connected to the outlet from the medium- or low-pressure compressor, the high-pressure working fluid discharge port of the cascade pressure exchanger is connected to the low-pressure working fluid supply port 8 of the cascade gas generator 1. Meanwhile, the air is compressed to the maximum pressure in the high-pressure compressor (not shown in the drawings) and heated in the combustion chamber, then the hot gas acts as a compressive medium that compresses the air in the cascade pressure exchanger (not shown in the drawings). Thus, the main air is pre-compressed and supplied to the low-pressure working fluid supply port of the cascade gas generator 1.

The engine may contain a cooling system 46 channels 5 of the rotor 3, (FIG. 5) at the same time, after passing through certain channels 5 of the low-pressure discharge port of the working fluid 9, when the channels, for example, are completely filled with air in them, in the side of the bypass channels 11, water, possibly pre-heated, is injected under pressure through the injectors of the cooling system 46.

The residual pulsation of the gas flow in front of the turbine can be extinguished in a special device for extinguishing gas pulses (not shown in the drawings), for example, in the form of a gas receiver made in the gas path in front of the high-pressure turbine.

The use of this invention will increase the efficiency of a gas turbine engine, reduce its weight and dimensions, and improve environmental characteristics.

What is claimed is:

1. Antoni cycle intermittent combustion engine, comprising at least one air (gas) compression device based on a cascade pressure exchanger, for example, a cascade gas generator, systems of fuel supply, ignition, start-up, monitoring, control, for example cooling, wherein the, it contains at least one cascade gas generator made on the basis of a cascade pressure exchanger, including a housing in which a rotor is installed with the possibility of rotation, with channels made along the circumference of the rotor parallel to the shaft (axially), or radially, or diagonally, or combined axial and radially, from the side of the inlet and outlet openings of the channels to the ends of the rotor with a minimum gap, for example, with the possibility of regulating it and/or, for example, with the possibility of performing any gap seals, the walls of the housing are adjacent, in which ports (windows) are formed with the possibility of feeding into the rotor channels and removing working fluid (working fluids) from them, when the rotor rotates, a cascade gas generator is integrated into the engine, for example, in such a way that a gas duct with a low-pressure working fluid, for example, air from the atmosphere, from a fan, or from a low-/medium-/high-pressure compressor, or air having passed a part of the low-pressure stages of a high-pressure compressor, is connected to the supply port of the low-pressure working fluid of a cascade gas generator on one side of the rotor, and on the opposite side of the rotor, for example, on the contrary, possibly, with the possibility of earlier opening of the rotor channels into it a port is built in the housing for the discharge of a low-pressure working fluid, for example, combustion products and/or a mixture of air and combustion products, for example, into the atmosphere (into the second circuit of a bypass turbojet engine) or into a medium- or low-pressure turbine, further, along the direction of rotation of the rotor, from the inlet side or from the outlet side of the low-pressure working fluid (or from both sides), fuel supply ports, in which, for example, fuel injectors are mounted, with the possibility of injecting liquid or compressed gaseous (or pulverized) fuel under pressure into the rotor channels, are built in the wall of the housing, and for example, further, after that along the direction of rotation of the rotor, openings are made in which spark plugs and/or detonation initiators are installed, further, along the direction of rotation of the rotor, for example, from the side of the low-pressure working fluid supply port, the port of discharge of the working fluid into the pressure cavity (pressure channel) is made, then, along the direction of rotation of the rotor, the port of supply of the working fluid to the rotor channels from the pressure cavity is made, opposite, (possibly with some displacement along the direction opposite to the rotation of the rotor) the port of discharge of the high-pressure working fluid is made in a housing, for example, on the side of the port of discharge of a low-pressure working fluid and connected to an expansion device, for example in the form of a turbine, for example a high pressure one, meanwhile, the walls of the housing located between the ports are made to ensure the possibility of overlapping of the inlet and outlet openings of at least one rotor channel when the rotor rotates, also, along the direction of rotation of the rotor, behind and in front of the port of discharge of the low-pressure working fluid, and/or on the opposite side of the rotor behind and in front of the port of supply of the low-pressure working fluid, a number of ports (windows) are connected in pairs by bypass (mass transfer) channels in such a way that the ports built, for example, behind the port of discharge of the low-pressure working fluid, along the direction of rotation of the rotor, are connected to the ports built in front of the port of discharge of the low-pressure working fluid, along the direction of rotation of the rotor, with the possibility of a sequential increase in pressure in the rotor channels, as the channels are removed from the discharging port of the low-pressure working fluid, when the rotor rotates, and the ports built, along the direction of rotation of the rotor, in front of the port of discharge of the low-pressure working fluid, are made with the possibility of successively reducing the pressure of the working fluid in the channels of the rotor, during its rotation, as the channels approach the port of discharge of the low-pressure working fluid.

2. An engine of claim 1, wherein the rotor of a cascade gas generator, for example, along the radius of the rotor, several rows of channels are made, at least two rows, for example, with the displacement of channels in some rows relative to channels in other rows, the walls of the housing located between the ports are made with the possibility of overlapping the inlet and outlet openings of at least one channel in each row of the rotor channels, for example, sequentially, when the rotor rotates.

3. An engine of claim 2, wherein the cascade gas generator is made in the form of a cascade motor-compressor, meanwhile, the fuel supply ports, and the openings located further along the direction of rotation of the rotor, in which spark plugs and/or detonation initiators are installed, are built opposite to a part of the rows of channels, at least, opposite to one row of channels, for example, located in the middle rows of channels, while from the side of the discharge port of the high-pressure working fluid of the cascade motor-compressor, this row (these rows) of channels is blocked by the wall of the housing, despite the fact that the outlet openings of the channels in the other row (in other rows) are connected to the discharge port of the high-pressure working fluid, and on the opposite side, the inlet openings of all rows of rotor channels are open into the pressure cavity connecting all the inlet openings of all channels exiting into it.

4. An engine of claim 1 or 2, wherein the pressure cavity (channel) is connected by a high-pressure bypass channel directly and/or through a port made on the opposite side of the rotor from the port of discharge of the working fluid into the pressure cavity (channel) with an additional port of supply of the working fluid into the rotor channels, at least one row of rotor channels, with that port built—along the direction of rotation of the rotor—in front of the sector of the wall of the housing, in which the fuel supply ports are built, for example, on the same side of the housing as the fuel supply ports, or on the opposite side of the rotor, and it is also possible that on both sides of the rotor in the walls of the housing additional ports for supplying the working fluid to the rotor channels are built, with these ports connected to high-pressure bypass channels.

5. An engine of claim 1 or 2, wherein the in the housing of the cascade gas generator, along the direction of rotation of the rotor, in the part in front of the pressure cavity or in front of the port of discharge of the working fluid into the pressure cavity (channel), a port or opening is built connected by an ultra-high-pressure bypass channel with a port or opening built on the same side of the rotor in the wall of the housing in front of or behind the sector of the wall of the housing, along the direction of rotation of the rotor, with fuel supply ports and openings with spark plugs and/or with detonation initiators, or this opening (port) is built right behind the fuel supply port, along the direction of rotation of the rotor, for example, at the same level (in the same sector) with openings with spark plugs and/or with detonation initiators.

6. An engine of claim 2, wherein at least one row of rotor channels is designed with the possibility of periodically combining channels with a high-pressure cooling air (gas) discharge port, which, in turn, is connected to the cooling system of, at least, high-pressure turbine, meanwhile the bypass (mass transfer) channels, connected to the ports built in the housing from the side of this row of channels, are built from the side of the supply port of the low-pressure working fluid of the cascade gas generator, meanwhile, along the direction of rotation of the rotor, behind the port connected to the last bypass (mass transfer) channel, which is built behind the low-pressure working fluid supply port, a port connected by a high-pressure bypass channel with a pressure cavity (channel) can be built, and then, along the direction of rotation of the rotor, a port is built, which is connected by an ultra-high-pressure bypass channel with a port built in the housing of a cascade gas generator, along the direction of rotation of the rotor, in front of the port of discharge of the working fluid into the pressure cavity, then, along the direction of rotation of the rotor, from the side opposite to the high-pressure cooling air discharge port, a port connected to the air cavity (channel) is built, after which, along the direction of rotation of the rotor, in the wall of the housing a port is built, connected to the supply from the air cavity (channel), made opposite (possibly with some displacement) to the high-pressure cooling air discharge port, further, along the direction of rotation of the rotor, a port is built connected to the port of discharge of the working fluid into the pressure cavity (channel), after which a number of ports are built connected by bypass (mass transfer) channels connecting ports built in the wall of housing of the cascade gas generator, in front of the low-pressure working fluid supply port, along the direction of rotation of the rotor, and behind it.

7. An engine of claim 3, wherein the discharge port of the high-pressure working fluid of a cascade motor compressor (cascade gas generator in the form of a motor compressor) is connected to at least one heat supply device, for example to a regenerative or recuperative heat exchanger and/or to a combustion chamber, the outlet of which is connected to a turbine, for example a high-pressure one, meanwhile, the cooling system of the turbine, at least of a high-pressure one, can also be connected to the discharge port of the high-pressure working fluid of the cascade motor compressor, and the side of the heat exchanger, where the heat supply to the high-pressure working fluid is located, can be connected, with the possibility of heat removal from the low-pressure working fluid, for example to a channel connected to the discharge port of the low-pressure working fluid of a cascade motor-compressor (cascade gas generator in the form of a motor-compressor).

8. An engine of claim 1 or 2, wherein the discharge port of the high-pressure working fluid is connected to at least one nozzle of the active flow of at least one single-stage ejector, and the discharge port of the low-pressure working fluid can be connected to the input of the passive flow of this ejector (or ejectors), the output of which can be connected to the turbine.

9. An engine of claim 1 or 2, wherein the rotor shaft of a cascade gas generator (motor-compressor) is connected to the drive, for example from a gas turbine or electric motor, with the possibility of regulating the rotor speed and/or the rotor is made with the possibility of self-rotation, for example by means of special nozzles (channels) built in separate ports for supplying the working fluid to the rotor channels, for example also with the possibility of regulating the rotor speed, meanwhile the housing of the cascade gas generator can be sealed.

10. An engine of claim 1 or 2, wherein the pressure cavity (channel) between the compression devices of the working fluid, for example air between compressors and/or in the gas duct connected to the low-pressure working fluid supply port of the cascade gas generator (motor-compressor), at least one heat removal device is installed, for example a heat exchanger-cooler and/or a pressurized water (condensate) injection system.

11. An engine of claim 1 or 2, wherein the discharge port of the high-pressure working fluid of the cascade gas generator is connected to the jet nozzle of the first circuit of the air-jet engine, meanwhile, an afterburner can be made in front of this nozzle, and the discharge port of the low-pressure working fluid of the cascade gas generator can have an output into the second circuit of the air-jet engine in which the gas flow from the air intake can be an active flow in relation to the gas from the discharge port of the low-pressure working fluid of the cascade gas generator and can be a passive flow in relation to the active flow of the working fluid from the first circuit of the engine.

12. An engine of claim 1 or 2, wherein in the gas (air) path, behind the compressor of the gas turbine engine, a steam-gas cascade pressure exchanger is built, the low-pressure working fluid supply port of which is connected to the compressor, and the high-pressure working fluid supply port is connected to a steam line connected to a generator, for example water vapor (steam generator), for example to a heat recovery boiler installed in the gas path behind or in front of the low-pressure turbine of a gas turbine engine, the port of discharge of the high-pressure working fluid of the steam-gas cascade pressure exchanger is connected to the port of supply of the low-pressure working fluid of the cascade gas generator, and the port of discharge of the low-pressure working fluid, for example water vapor, is connected to at least one steam condenser, for example to a steam water (condensate) heater through at least, one steam and/or gas turbine, meanwhile, the steam water (condensate) heater is connected, at least, to the heat recovery boiler (steam generator) by a water (condensate) supply pipeline with a pump and for example a water treatment device, and may contain a fan or compressor with the possibility of air removal, for example to the low-pressure working fluid supply port of a steam-gas cascade pressure exchanger, and in the gas path, behind and in front of the low-pressure turbine stages, condensate separators can be installed connected by a condensate supply pipeline, at least with a steam water (condensate) heater, and additional coolers can also be installed, for example in the form of a heating system circuit.

13. An engine of claim 1 or 2, wherein ports of supply and discharge of the low-pressure working fluid of the cascade gas generator are made with the possibility of partially displacement of for example half of the combustion products into the port of discharge of the low-pressure working fluid, and the other part, for example half, into the port of discharge of the high-pressure working fluid, meanwhile, the ports connected by bypass channels, at least most of them, are built on the side of the discharge port of the high-pressure working fluid, and for example the fuel supply port is built on the side opposite to the port of the discharge of the high-pressure working fluid.

14. An engine of claim 2 or 3, wherein it contains a cascade motor-compressor, with a cascade gas generator built behind it, installed in the beginning, in the gas (air) path, along the direction of gas (air) movement, meanwhile, the low-pressure working fluid supply port of the cascade motor-compressor is connected to the compressor of the gas turbine engine, the high-pressure working fluid discharge port of the cascade motor-compressor is connected to the low-pressure working fluid supply port of the cascade gas generator by a channel that may contain a convective intercooler, or a water (condensate) injection system, the discharge port of the high-pressure working fluid of the cascade gas generator is connected to a high-pressure turbine, and the discharge port of the low-pressure working fluid is connected, for example, to a medium-pressure turbine, while the discharge port of the low-pressure working fluid of the cascade motor-compressor is connected, for example, to a low-pressure turbine.

15. An engine of claim 1 or 2, wherein it contains a device for injecting coolant into the rotor channels, meanwhile, in the walls of the cascade gas generator housing, including one made in the form of a motor-compressor, opposite to at least part of the channels in the rotor, which on the opposite side are combined completely or partially with ports connected to bypass (mass transfer) channels, with the possibility of increasing the pressure in these channels of the rotor, and possibly on the opposite side from the port connected to the high-pressure bypass channel, made with the possibility of increasing the pressure in these channels of the rotor, nozzles are made with the possibility of injection into the channels under pressure of a coolant, for example water, and possibly, at least in part of the channels, injection of both fuel and/or a mixture of fuel, for example, with water, meanwhile, at least one row of rotor channels, made to ensure the possibility of periodic combination with a high-pressure cooling air (gas) discharge port, which is connected to the cooling system of at least a high-pressure turbine, contains nozzles for injecting coolant (water) built in the housing, on the same side as the high-pressure cooling air discharge port, also possibly built on the same side as the channels, combined on the opposite side with a port connected to an ultra-high pressure bypass channel, built with the possibility of increasing the pressure in these channels of the rotor.

16. An engine of claim 12, Wherein in the walls of the housing of the steam-gas cascade pressure exchanger, opposite the channels in the rotor, on the opposite side combined completely or partially, with ports, connected to the bypass (mass transfer) channels, with the possibility of increasing the pressure in these channels of the rotor and possibly partially, opposite of the port of supply of the high-pressure working fluid to the steam-gas cascade pressure exchanger, nozzles are made with the possibility of injection of coolant (water) into the rotor channels under pressure, connected possibly through a pump (pumps), for example, to a cooling water tank, for example preheated.

17. An engine of claim 1 or 2, wherein it contains a cascade pressure exchanger, with a cascade gas generator built behind it, installed in the beginning, in the gas path, along the direction of gas (air) movement, meanwhile, the supply port of the high-pressure working fluid of the cascade pressure exchanger is connected to the outlet from the combustion chamber, the inlet of which is connected to the high-pressure compressor, the supply port of the low-pressure working fluid of the cascade pressure exchanger is connected to the outlet from the medium- or low-pressure compressor, the discharge port of the high-pressure working fluid of the cascade pressure exchanger is connected to the supply port of the low-pressure working fluid of the cascade gas generator by a channel that may contain a convective intercooler, or a water (condensate) injection system, the discharge port of the high-pressure working fluid of the cascade gas generator is connected to a high-pressure turbine, and the discharge port of the low-pressure working fluid is connected, for example, to a medium-pressure turbine, while the discharge port of the low-pressure working fluid of the cascade pressure exchanger is connected, for example, to a low-pressure turbine.

18. An engine of claim 1 or 2, wherein it contains a cooling system for at least the channels of the rotor of a cascade gas generator (motor-compressor), for example, made in the form of nozzles (nozzle) for injection of coolant under pressure, for example, water into the channels of the rotor, installed in ports (port) built in the wall of the housing, at least from the side of the bypass (mass transfer) channels, along the direction of rotation of the rotor, behind the port of discharge of the low-pressure working fluid.

19. An engine of claim 1 or 2, wherein it contains at least one pulse damping device (pressure equalization) of gas in the gas path, at least in front of the high-pressure turbine, for example, in the form of a receiver.
